(19) United States
(12) Patent Application Publication
(10) Pub. No.: US 2007/0209917 A1
(43) Pub. Date: Sep. 13, 2007

(54) LIGHT GUIDE FOR ILLUMINATING KEYPADS

(75) Inventors: CHIEN-AN CHIU, Shenzhen (CN); KUO-CHU CHANG, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,481

(22) Filed: Aug. 11, 2006

(30) Foreign Application Priority Data
Mar. 8, 2006 (CN) 200620056083.7

(51) Int. Cl. H01H 9/00

(52) U.S. Cl. 200/310

(57) ABSTRACT

A light guide (30) for illuminating a keypad (20) including a plurality of keys (22) includes a plurality of apertures (300) corresponding to the keys, a first end portion (32) defining at least one receiving hole (320) for receiving at least one light source, and a second end portion (34) opposite to the first end portion. A thickness of the first end portion is greater than that of the second end portion.

### CROSS-REFERENCE TO RELATED APPLICATION

This present application is related to two co-pending U.S. Patent Applications entitled “LIGHT GUIDE FOR ILLUMINATING KEYPADS,” recently filed with Attorney Docket Nos. US9499 and US9502, and assigned to the same assignee as that of the present application.

### FIELD OF THE INVENTION

The invention relates to light guides, and particularly to a light guide for illuminating a keypad or keyboard uniformly.

### DESCRIPTION OF RELATED ART

It is common to illuminate a keyboard or keypad of an electronic device, such as a mobile telephone, to facilitate nighttime use. Each individual key may be illuminated by a respective light source located directly behind the key. This arrangement is, however, very expensive since a separate light source is required for each key. Furthermore, the power dissipation of the mobile telephone is increased, and the standby time of the mobile telephone is shorter.

A more economical approach utilizes fewer distributed light sources and the light is directed towards the keys with the aid of a light guide in the form of a transparent plate. Referring to FIG. 4, a plan view of a conventional light guide 50 is shown. The light guide 50 comprises a plurality of V-shaped notches 52 defined at a periphery thereof, and an array of apertures 520 arranged in four rows and three columns. The apertures 520 are rectangular with rounded corners, corresponding to keys 60 of a keypad. Four light sources, such as light-emitting diodes, are located behind the light guide 50. In a vicinity of each of the light sources, the light guide 50 comprises a respective convex lens 70 formed integrally therewith. Aligned with each lens 70, adjacent to a front face of the light guide 50, there is provided a prismatic indentation 72, which offers four reflecting surfaces each having a triangular outline. The light from the light sources is collimated by the lenses 70 into a beam traveling transversely into the light guide 50, then the prismatic indentations 72 serve to direct the beam into a plane of the light guide 50 by means of total internal reflection to illuminate the keys 60. However the number of the light sources is four, and the power dissipation of the mobile telephone is still too great. In addition, the illumination is not uniform as the brightness of the keys 60 adjacent to the light sources is greater than that of the keys 60 away from the light sources, and the cost of manufacturing the light guide 50 is greater because the lens 70 is formed integrally with the light guide 50.

Therefore, a heretofore unaddressed need exists in the industry to overcome the aforementioned deficiencies and inadequacies.

### SUMMARY OF THE INVENTION

An aspect of the invention provides a light guide for illuminating a keypad including a plurality of keys. The light guide includes a plurality of apertures corresponding to the keys, a first end portion defining at least one receiving hole for receiving at least one light source, and a second end portion opposite to the first end portion. A thickness of the first end portion is greater than that of the second end portion.

Another aspect of the invention provides an electronic device. The electronic device includes a keypad comprising a plurality of keys, a light guide disposed under the keypad, and at least one light source. The light guide includes a plurality of apertures corresponding to the keys, a first end portion defining at least one receiving hole, and a second end portion opposite to the second end portion. The at least one light source is received in the at least one receiving hole of the light guide. A thickness of the first end potion is greater than that of the second end portion.

Other advantages and novel features will become more apparent from the following detailed description of preferred embodiments when taken in conjunction with the accompanying drawings, in which:

### BRIEF DESCRIPTION OF THE DRAWINGS

FIG. 1 is an exploded, isometric view of an electronic device of an exemplary embodiment of the present invention, the electronic device comprising a keypad and a light guide;

FIG. 2 is a schematic diagram of the light reflecting in the light guide of FIG. 1;

FIG. 3 is an inverted, assembled view of FIG. 1; and

FIG. 4 is a plan view of a conventional light guide.

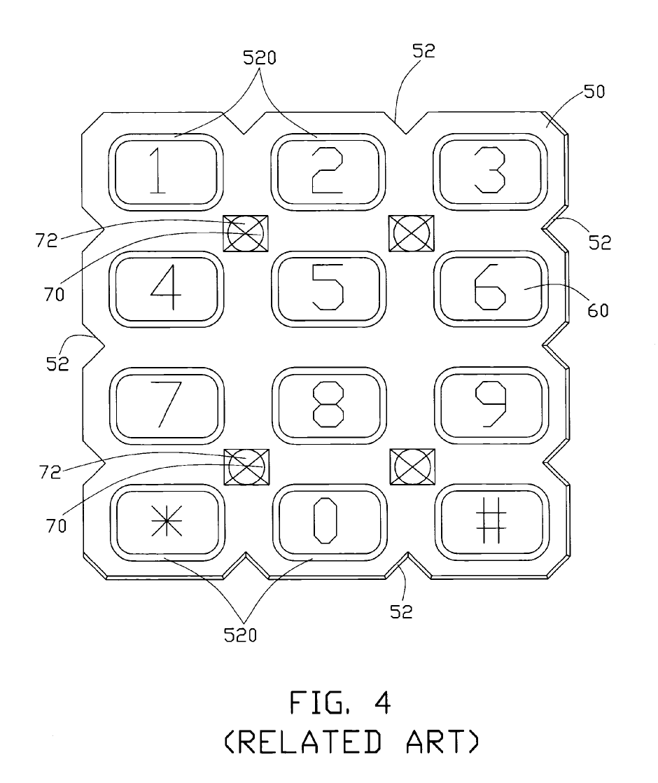

### DETAILED DESCRIPTION OF THE INVENTION

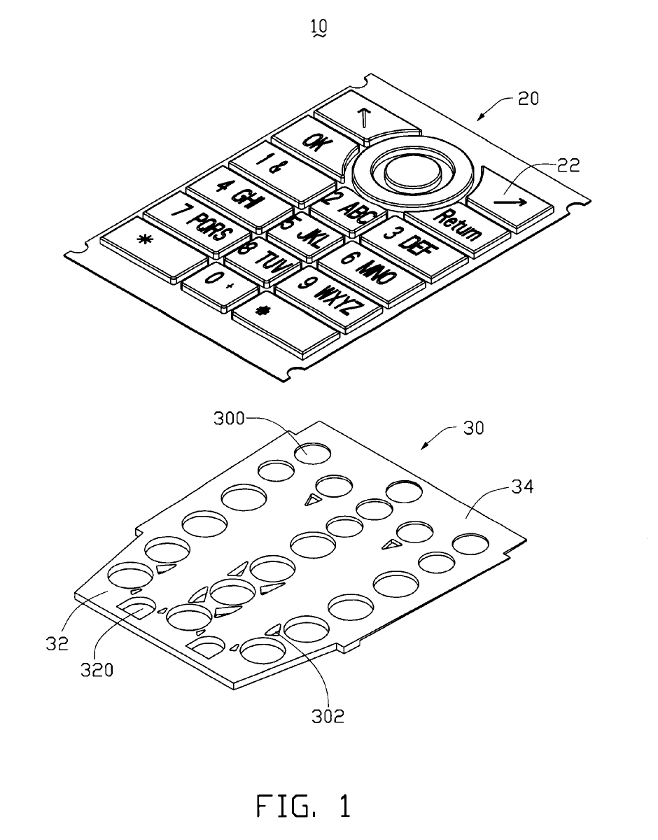

Referring to FIG. 1, an electronic device 10 of an exemplary embodiment of the present invention comprises a keypad 20 and a light guide 30.

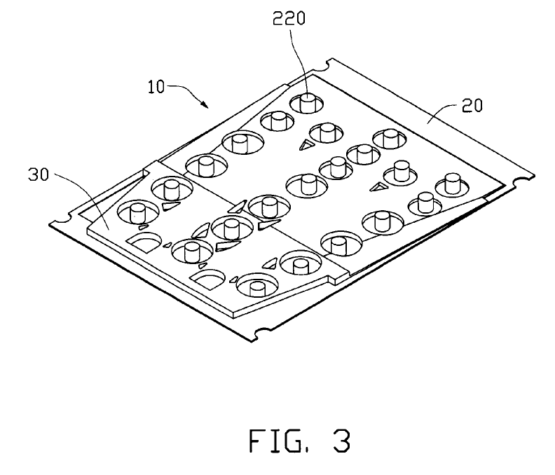

Referring also to FIG. 3, the keypad 20 has a generally rectangular profile. The keypad 20 comprises a plurality of keys 22. Each of the keys 22 comprises a key column 220.

The light guide 30 can be mounted on a circuit board comprising two light sources, for example, two light-emitting diodes (not shown). The light guide 30 is a transparent plate. The light guide 30 comprises a first end portion 32, and a second end portion 34 connecting with the first end portion 32. A surface of the light guide 30 is defined by the first, second end portions to face the keypad 20 for emitting light from the light guide 30 toward the keypad 20. A thickness of the first end portion 32 is greater than that of the second end portion 34, i.e., the light guide is gradually tapered from the first end portion 32 to said second end portion 34. Lengthwise, in cross-section, the second end portion 34 is generally wedge-shaped. A thickness of the second end portion 34 gradually reduces along a direction from the first end portion 32 to the second end portion 34. The second end portion 34 further comprises a pair of generally triangular slope portions disposed at opposite sides thereof.

The light guide 30 comprises a plurality of apertures 300 corresponding to the keys 22 of the keypad 20. The key columns 220 of the keys 22 are received in the corresponding apertures 300. The apertures 300 are generally positioned in three columns. One of the columns of the apertures 300 is positioned in a lengthwise central line of the light guide 30. Receiving holes 320 are symmetrically positioned to either side of an end of the central column of the apertures 300 in the first end portion 32 to receive the light sources therein, and to define a surface therein respectively to accept light from the light sources. The light guide 30 further comprises two apertures 300 defined in the second end portion 34 and respectively positioned on axes of the receiving holes 320. Thus, the keys 22 of the keypad 20 are positioned in an illumination range of 120° corresponding to that of the light sources. In the exemplary embodiment, the light sources are light-emitting diodes. A preferred illumination range within which power of illumination from the light-emitting diode is greatest is 1200 centered about the axis of each receiving hole 320. Thus, at least one portion of each key 22 of the keypad 20 is positioned in the illumination range of 120° corresponding to that of the light sources.

The light guide 30 also comprises a plurality of holes 302. Each hole 302 is triangular shaped. Some of the holes 302 are disposed near the apertures 300 adjacent to the receiving holes 320, and two of the holes 302 are respectively positioned on the axes of the receiving holes 320. That is, the holes 302 are disposed near the keys 22 where illumination is greatest. Thereby, the light from the light sources can be easily introduced into the keypad 20, and illuminate the keypad 20 uniformly.

In assembly, the key columns 220 of the keypad 20 are received in the corresponding apertures 300 of the light guide 30, thereby the keypad 20 and the light guide 30 are mounted together.

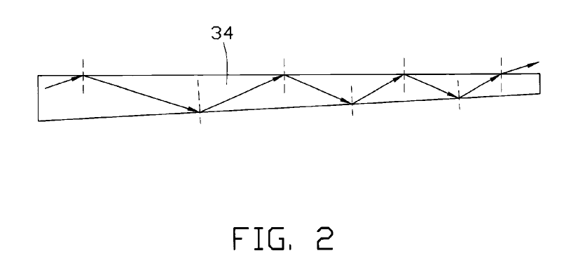

Referring to FIGS. 1-3, in use, the light from the light source received in the receiving hole 320 is introduced into the light guide 30, and reflects within the light guide 30. Because the thickness of the first end portion 32 is greater than that of the second end portion 34, and the light sources are received in the receiving holes 320 of the first end portion 32, the number of reflections that the light reflects within the first end portion 32 is less than that of the second portion 34. Meanwhile, because the thickness of the second end portion 34 reduces gradually along the direction from the first end portion 32 to the second end portion 34, the number of reflections that the light reflects within the second end portion 34 increases gradually along the direction from the first end portion 32 to the second end portion 34. In this way, the loss of illuminating power as the light travels through the light guide 30 is compensated for by the increase in density of the number of reflections over distance. Thus, a brightness of the portion of the light guide 30 away from the light source is comparable to a brightness of the portion of the light guide 30 near the light source, so that a uniform brightness is obtained. Furthermore, the number of the light sources used in the electronic device 10 is reduced, and the standby time of the electronic device 10 is prolonged.

Because of the slope portions 340, the light can be easily introduced into opposite sides of the second end portion 34. In this way, a brightness of the sides of the second end portion 34 is comparable to a brightness of the portion of the light guide 30 near the light source, so that a uniform brightness is obtained.

While an exemplary embodiment has been described above, it should be understood that it have been presented by way of example only and not by way of limitation. Thus the breadth and scope of the present invention should not be limited by the above-described exemplary embodiment, but should be defined only in accordance with the following claims and their equivalents.

What is claimed is:

1. A light guide for illuminating a keypad, wherein the keypad includes a plurality of keys, the light guide comprising:
a plurality of apertures, corresponding to the keys;
a first end portion defining at least one receiving hole for receiving at least one light source; and
a second end portion connecting with the first end portion;
wherein a thickness of the first end portion is greater than that of the second end portion.

2. The light guide as claimed in claim 1, wherein lengthwise, in cross-section, the second end portion is generally wedge-shaped.

3. The light guide as claimed in claim 2, wherein a thickness of the second end portion reduces gradually along a direction from the first end portion to the second end portion.

4. The light guide as claimed in claim 1, wherein the second end portion further comprises a pair of generally triangular slope portions disposed at opposite sides thereof.

5. The light guide as claimed in claim 1, wherein the apertures are generally positioned in three columns, and one of the columns of the apertures is positioned in a lengthwise central line of the light guide.

6. The light guide as claimed in claim 5, wherein the at least one receiving hole is two receiving holes, and the receiving holes are symmetrically positioned to either side of an end of the central column of the apertures.

7. The light guide as claimed in claim 6, further comprising a plurality of triangular holes.

8. The light guide as claimed in claim 7, wherein some of the triangular holes are disposed near the apertures adjacent to the receiving holes, and two of the triangular holes are respectively positioned on axes of the receiving holes.

9. An electronic device, comprising:
a keypad comprising a plurality of keys;
a light guide disposed under the keypad, the light guide comprising a plurality of apertures corresponding to the keys, a first end portion defining at least one receiving hole, and a second end portion connecting with the second end portion; and
at least one light source received in the at least one receiving hole of the light guide; wherein a thickness of the first end potion is greater than that of the second end portion.

10. The electronic device as claimed in claim 9, wherein lengthwise, in cross-section, the second end portion is generally wedge-shaped.

11. The electronic device as claimed in claim 10, wherein a thickness of the second end portion reduces gradually along a direction from the first end portion to the second end portion.

12. The electronic device as claimed in claim 9, wherein the second end portion further comprises a pair of generally triangular slope portions disposed at opposite sides thereof.

13. The electronic device as claimed in claim 9, wherein the apertures are generally positioned in three columns, and one of the columns of the apertures is positioned in a lengthwise central line of the light guide.

14. The electronic device as claimed in claim 13, wherein the at least one receiving hole is two receiving holes, and the receiving holes are symmetrically positioned to either side of an end of the central column of the apertures.

15. The electronic device as claimed in claim 14, further comprising a plurality of triangular holes.

16. The electronic device as claimed in claim 15, wherein some of the triangular holes are disposed near the apertures adjacent to the receiving holes, and two of the triangular holes are respectively positioned on axes of the receiving holes.

17. An electronic device comprising:
a keypad comprising a plurality of keys installable and extending along a user-accessible side of said electronic device;
a light source installable in said electronic device for illuminating said plurality of keys of said keypad; and
a light guide installable in said electronic device beside said light source and said keypad, respectively, to transmit light from said light source toward said keypad through said light guide, said light guide comprising a first surface facing said light source to accept said light from said light source into said light guide and a second surface facing said keypad to emit said light out of said light guide toward said keypad, said light guide tapering when said light guide extends farther away from said first surface thereof so as to enhance uniformity of emission of said light out of said second surface of said light guide.
